(19) United States
(12) Patent Application Publication
(10) Pub. No.: US 2026/0099446 A1
(43) Pub. Date: Apr. 9, 2026

(54) MEMORY DEVICE WITH HOST-INITIATED CACHE OPERATION

(71) Applicant: Samsung Electronics Co., Ltd., Suwon-si (KR)

(72) Inventors: Ramdas P. KACHARE, Pleasanton, CA (US); Caroline Diana KAHN, San Jose, CA (US); Mohammadreza SOLTANIYEH, Sunnyvale, CA (US); Edmund C. AU, Cupertino, CA (US); Michael WASEF, San Jose, CA (US); Dongwan ZHAO, San Jose, CA (US)

(21) Appl. No.: 19/271,774

(22) Filed: Jul. 16, 2025

Related U.S. Application Data
(60) Provisional application No. 63/703,800, filed on Oct. 4, 2024.

(51) Int. Cl. G06F 12/0862; G06F 12/12

(52) U.S. Cl. CPC G06F 12/0862; G06F 12/12; G06F 2212/602

(57) ABSTRACT

A memory device with host-initiated cache operation. In some embodiments, a method includes: receiving, from a host, by a memory device, a prefetch command; and based on receiving the prefetch command, reading a data value from a memory of the memory device into a cache of the memory device.

### CROSS-REFERENCE TO RELATED APPLICATION(S)

The present application claims priority to and the benefit of U.S. Provisional Application No. 63/703,800, filed Oct. 4, 2024, entitled “HOST TIERED MEMORY MODULE APPLICATION PROGRAMMING INTERFACES (APIS) FOR EXTENDED FEATURES”, the entire content of which is incorporated herein by reference.

### FIELD

One or more aspects of embodiments according to the present disclosure relate to data storage, and more particularly to a memory device with host-initiated cache operation.

### BACKGROUND

In a computing system, a host, which may include a central processing unit (CPU), may interact with other system elements, including a host memory. Such memory may include dynamic random-access memory (DRAM) or flash memory.

It is with respect to this general technical environment that aspects of the present disclosure are related.

### SUMMARY

According to an embodiment of the present disclosure, there is provided a method, including: receiving, from a host, by a memory device, a prefetch command; and based on receiving the prefetch command, reading a data value from a memory of the memory device into a cache of the memory device.

In some embodiments, the memory of the memory device is larger than the cache of the memory device.

In some embodiments, the memory of the memory device includes nonvolatile memory.

In some embodiments, the memory of the memory device includes a solid-state drive.

In some embodiments, the memory device includes a controller, the controller including a processing circuit including a stored-program computer.

In some embodiments, the memory device further includes a controller memory connected to the controller.

In some embodiments, the method further includes: receiving, from the host, by the memory device, a command to place a lock on the data value; and based on the command, placing a lock on the data value.

In some embodiments, the method further includes: receiving, from the host, by the memory device, a command to release the lock on the data value; and based on the command, releasing the lock.

In some embodiments, the method further includes: receiving, from the host, by the memory device, a command to evict the data value from the cache of the memory device; and based on the command, evicting the data value from the cache of the memory device.

In some embodiments, the method further includes: receiving, from the host, by the memory device, a command to flush a modified data value from the cache of the memory device to the memory of the memory device; and based on the command, flushing the data value.

In some embodiments, the method further includes: receiving, from the host, by the memory device, a status check command; and based on the status check command, transmitting status information to the host.

In some embodiments, the status information includes a status of a command.

In some embodiments: the status information includes an operating statistic of the memory device, and the operating statistic includes an access frequency of a memory location.

In some embodiments, the method further includes: determining that the cache of the memory device is full and that all data values in the cache are locked; and based on determining that the cache of the memory device is full and that all data values in the cache are locked, evicting a locked data value from the cache of the memory device.

According to an embodiment of the present disclosure, there is provided a memory device, including: a memory; and a cache, the memory device being configured: to receive, from a host, a prefetch command; and based on receiving the prefetch command, to read a data value from the memory into the cache.

In some embodiments, the memory of the memory device includes nonvolatile memory.

In some embodiments, the memory device is further configured: to receive, from the host, a command to place a lock on the data value; and based on the command, to place a lock on the data value.

In some embodiments, the memory device is further configured: to receive, from the host, a command to evict the data value from the cache of the memory device; and based on the command, to evict the data value from the cache of the memory device.

According to an embodiment of the present disclosure, there is provided a system, including: a host; and a memory device, the memory device including: a memory; and a cache, the host being configured to send, to the memory device, a prefetch command, and the memory device being configured, based on receiving the prefetch command, to read a data value from the memory into the cache.

In some embodiments, the host is further configured: to send, to the memory device, a command to place a lock on the data value; and based on the command, to place a lock on the data value.

### BRIEF DESCRIPTION OF THE DRAWINGS

These and other features and advantages of the present disclosure will be appreciated and understood with reference to the specification, claims, and appended drawings wherein:

FIG. 1A is a block diagram of a computing system, according to an embodiment of the present disclosure;

FIG. 1B is a block diagram of a computing system, according to an embodiment of the present disclosure;

FIG. 2A is a flow diagram of operations performed by an application programming interface layer, according to an embodiment of the present disclosure;

FIG. 2B is a data flow diagram showing caching, eviction and flushing operations, according to an embodiment of the present disclosure;

FIG. 3A is a first portion of a flow chart of a method, according to an embodiment of the present disclosure; and

FIG. 3B is a second portion of the flow chart, according to an embodiment of the present disclosure.

### DETAILED DESCRIPTION

The detailed description set forth below in connection with the appended drawings is intended as a description of exemplary embodiments of a memory device with host-initiated cache operation provided in accordance with the present disclosure and is not intended to represent the only forms in which the present disclosure may be constructed or utilized. The description sets forth the features of the present disclosure in connection with the illustrated embodiments. It is to be understood, however, that the same or equivalent functions and structures may be accomplished by different embodiments that are also intended to be encompassed within the scope of the disclosure. As denoted elsewhere herein, like element numbers are intended to indicate like elements or features.

A computing system may include a host and one or more memory devices connected to the host by a suitable communications link, e.g., Compute Express Link (CXL). Each memory device may be treated by the host as an area of memory, e.g., the host may save data to the memory device using store instructions and read data from the memory device using load instructions. The load and store instructions may be part of the host central processing unit instruction set. A memory device connected to a host may include (i) a large amount of nonvolatile memory, which may be relatively inexpensive per unit of storage (e.g., per bit of storage) and (ii) a relatively small cache including dynamic random-access memory, which may be more expensive per unit of storage and which may exhibit significantly better performance (e.g., lower latency or higher throughput).

In such a system, the memory device may keep data that is predicted to be accessed soon by the host in the cache; to the extent that the predictions are accurate the relatively high latency of the nonvolatile memory may be hidden from the host, which may experience only the performance characteristics of the cache. In some circumstances, however, it may be challenging for the memory device to make such predictions, and the performance experienced by the host may be a mixture of the relatively high performance of the cache and the relatively poor performance of the nonvolatile memory.

As such, in some embodiments a memory device may support host-initiated cache operation. In such an embodiment, a mechanism may be used that allows a user or kernel process (e.g., an application running on the host) to influence the cache policy of the memory device. Such influencing may include, for example, commanding the memory device to prefetch data into the cache (e.g., to read data from the nonvolatile memory into the cache), or to evict data from the cache. Because the application may have more information than the memory device about workloads and what data the application will need soon, predictions made by the application about data that will be accessed soon may be more accurate than predictions made by the memory device, and the performance of the system may improve if the application is able to influence the cache policy of the memory device. Commands used by the application for this purpose may include a command to prefetch a range of addresses, a command to evict a range of addresses, or a command to flush a range of addresses. An application programming interface layer for providing such commands may also include commands for checking on the progress of a previously sent command, and for obtaining operating statistics from the memory device.

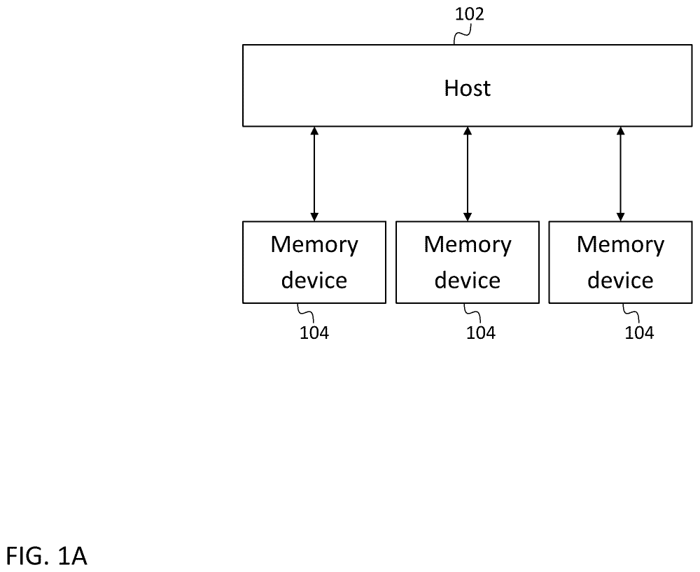

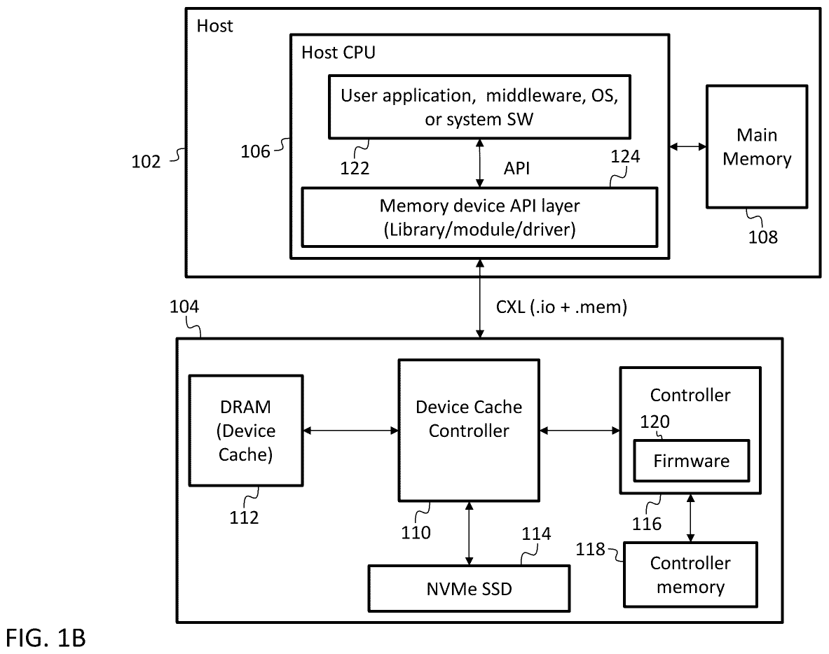

FIG. 1A shows a system-level diagram of a computing system. The system includes a host 102 and a plurality of memory devices 104. Three memory devices 104 are shown, but this disclosure is not limited to such a configuration, and in some embodiments, more or fewer memory devices 104 are present and connected to the host 102.

FIG. 1B shows a system-level diagram of a computing system with a single memory device 104, in some embodiments. Like the systems illustrated in FIG. 1A, the system of FIG. 1B system includes a host 102. The system of FIG. 1B further includes a memory device 104, which is connected to (or part of) the host 102. The host 102 includes a host central processing unit (host CPU) 106 and a main memory, or “host memory” 108. The memory device 104 may include a memory device cache controller 110, which may be connected to a memory device cache 112, a memory device nonvolatile memory 114 (which may operate as the backing store of the memory device 104), and a memory device controller 116. In some embodiments, the memory device cache 112 may be or include dynamic random-access memory (DRAM). The memory device controller 116 may be a stored-program computer (e.g., a microprocessor) such as an Advanced reduced instruction set computer (RISC) Machines (ARM) processor. The memory device controller 116 may be connected to a memory device controller memory 118. The memory device controller memory 118 may be or include dynamic random-access memory. The memory device controller 116 may include memory device controller firmware 120 (e.g., instructions stored in read-only memory (ROM)) that may be executed by the memory device controller 116. In other embodiments, the memory device control firmware 120 may be partially or entirely located externally to the memory device controller 116.

The backing store of the memory device 104 (e.g., the memory device nonvolatile memory 114) may include storage media having characteristics that make it suitable for use as a backing store. For example, the memory device nonvolatile memory 114 media may be inexpensive per unit of storage, or the memory device nonvolatile memory 114 may be nonvolatile. In some embodiments, the memory device nonvolatile memory 114 is or includes flash memory, e.g., not-AND (NAND) flash memory. In some such embodiments, the memory device nonvolatile memory 114 is or includes a solid-state drive (SSD) that complies with the nonvolatile memory express (NVMe) standard. In some embodiments, volatile memory is used as a backing store, instead of (or in addition to) the memory device nonvolatile memory 114.

The memory device cache 112 include storage media having characteristics that make it suitable for use as a cache. For example, the memory device cache 112 media may have performance characteristics, such as low latency or high throughput, that may improve system performance. In some embodiments, the memory device cache 112 is or includes dynamic random-access memory.

In operation, one or more user or kernel processes 122 (e.g., user applications, middleware processes, operating system (OS) processes, or system software (SW) processes) may run on the host CPU 106. Each of the user or kernel processes 122 may, during operation, make use of the memory device 104 for data storage, e.g., using load and store instructions (which may be part of the instruction set of the host CPU 106). Each of the user or kernel processes 122 may, in the code that is executed, use virtual addresses. These addresses may be translated to host physical addresses by a memory management unit (MMU) of the host 102; the host physical addresses may correspond to physical locations in memory (e.g., in the memory device 104 or in the host memory 108). Whether a load or store instruction accesses the host memory 108 or the memory device 104 may depend on the host physical address corresponding to the virtual address that is present as an argument of the load or store instruction. For example, a first range of host physical addresses may be mapped to the host memory 108, and a second range of host physical addresses, disjoint from the first range of host physical addresses, may be mapped to the memory device 104. Accesses to the memory device 104 resulting from the execution of load or store instructions by the central processing unit (e.g., the Host CPU 106) of the host 102 may be made through the CXL.mem protocol.

In the system of FIG. 1B, the memory device cache controller 110 may cache, or prefetch, data from the memory device nonvolatile memory 114, or evict data form the memory device cache 112 to the memory device nonvolatile memory 114 using algorithms based on usage patterns. For example, when a sequence of consecutive host physical addresses is read, the memory device cache controller 110 may (i) cache the data that was read, and (ii) predict that additional host physical addresses in the sequence are likely to be read, and it may prefetch data from a number of such addresses, in anticipation of such read operations. As another example, if the data in a range of memory addresses has not been accessed in some time, it may be evicted. As another example, if the memory device cache 112 is full or nearly full (e.g., sufficiently full to prevent a prefetch or caching operation that is to be made) then the least recently used data may be evicted.

Such a method of operation may however not benefit from information that the user or kernel process 122 may have regarding future memory accesses, and information that the application may have regarding data that should be “persisted” (e.g., stored in nonvolatile memory). The lack of such benefits may result in a missed opportunity to achieve improved performance.

As such, in some embodiments, an application programming interface layer (API layer) 124 is used to allow user or kernel processes 122 to influence or control the movement of data, in the memory device 104, between the memory device nonvolatile memory 114 and the memory device cache 112. The application programming interface 124 may allow a user or kernel process 122 to influence the cache policy of the memory device 104 by sending commands, over the CXL.io protocol (or over any other suitable interface and protocol), to the memory device 104. Such commands may, as mentioned above, include prefetch and evict commands which may arrange for the data the user or kernel process 122 will need to be available in the cache when the data is needed. As such, two distinct types of interaction between the host 102 and the memory device 104 may take place. One of these types of interaction is a memory access interaction, that is triggered when the user or kernel process 122 performs a load or store operation on a memory location that corresponds to a location within a range of host physical addresses mapped to the memory device 104. Such accesses may be performed through the CXL.mem protocol, and they may involve reading from or writing to the memory device cache 112 (or also reading from the memory device nonvolatile memory 114 in the event of a cache miss, e.g., if the address to be read is not in the cache). A second type of interaction is a command, sent to the memory device 104 as a request message over CXL.io, which commands, for example, that the memory device 104 prefetch a range of addresses, or evict or flush a range of addresses, or that the memory device 104 report operating statistics.

The memory device 104 may have a unique identifier (ID) which it may send to the host upon request. For a memory device 104 that is connected to the host by a Compute Express Link (CXL) communications link, for example, the application programming interface layer 124 may function as follows; other types of memory device, e.g., ones following other protocols, may operate in an analogous manner. The application programming interface layer 124 may expose the extended features of the memory device 104 to the user or kernel processes 122. The application programming interface 124 may include libraries, modules, and drivers as shown in FIG. 1B. In other embodiments, the application programming interface 124 may include one or more other suitable features. The application programming interface layer 124 may communicate with the Compute Express Link Memory Module-Hybrid device via a request and response message over the Compute Express Link connection to discover the device capabilities, handle feature-specific commands, and check the status or progress of commands.

During initialization of the application programming interface layer 124, the host 102 may find all Compute Express Link Memory Module-Hybrid memory devices available in the system and send a discovery request to each, to determine the capabilities including extended feature support and feature parameters. The application programming interface layer 124 may maintain a list of the identifiers of the memory devices 104, the list including the address of each memory device 104, the extended features supported by each memory device 104, and the parameters of each memory device 104.

The application programming interface layer 124 may support a number of outstanding host commands and maintain a table of the outstanding host commands, the table including, for each command, a unique command identifier, the identifier of the memory device 104 handling the command, and the progress percentage and completion status. When an outstanding command has been completed (successfully or not) it may be removed from the table, e.g., if space is needed in the table. When the application programming interface layer 124 reaches a set maximum number of outstanding commands, it may return an error (e.g., “busy” or “error”) in response to any calls to the application programming interface layer 124 until a command has been completed so that the number of outstanding commands is less than the maximum number of outstanding commands.

The application programming interface layer 124 may handle communication with any suitable number of memory devices 104. Each command may be sent from the host 102 to the memory device 104 as part of a request message (e.g., a CXL request message). Each request message for a memory device 104 may contain a unique command identifier (ID) (or “tag”), and the associated response or any asynchronous messages from the memory device 104 may contain the same unique command identifier. The application programming interface layer 124 may handle correlating the command and response messages; for example, when the application programming interface layer 124 receives a command from a user or kernel process 122, it may send a corresponding command to the memory device 104, and when the application programming interface layer 124 receives a response from the memory device 104, the application programming interface layer 124 may make the response part of the response the application programming interface layer 124 returns to the user or kernel process 122. In the event of a response indicating completion status (success or fail) or progress, the Host API layer may update the appropriate entry in the outstanding command table.

The application programming interface layer 124 may support common functionality and specific extended features. The extended features may include host-managed cache policy, hit rate reporting, and host-managed data persistence.

Table 1 shows an initialization command and a cleanup command, as well as definitions of several data structures that are used as arguments or return values. The mm_init( ) command initializes the application programming interface layer 124, discovers all of the connected memory devices 104, and returns an integer indicating how many memory devices 104 were discovered. In command names and type names respectively, “mm” and “MM” may refer to the memory module API. The mm_close( ) command cleans up the application programming interface layer 124 when it is being shut down (e.g., when use of the application programming interface layer 124 is terminating). The command mm_checkprogress, which may be called by the user or kernel process 122 to determine progress of the command or whether it has been completed, takes a command identifier as an argument (the argument requestID) and returns a structure of type MM_PROG.

Various structures are also specified in Table 1. For example, MM_CMD_OPTION is a structure that may be passed in to the mm_prefetch, evict, and flush commands, and which may include (i) an integer enable_checkprogrees for enabling fine (or “fine grained”) progress reporting (e.g., reporting of progress in terms of percentage complete) by the memory device 104 and (ii) a pointer callback_function to a callback function that the application programming interface layer 124 may call to report status to the user or kernel process 122 that sent the command.

TABLE 1

| | |
|---|---|
| int mm_init ( ) | Initialize the MM Host API layer and |
| | discover the MM devices, capabilities and |
| | configurations. |
| void mm_close ( ) | Clean up the MM Host API layer. |
| Struct MM_PROG mm_checkprogress | Check the progress of a previously issued |
| ( | command to a MM device. |
| uint16_t requestID; | |
| ) | |
| struct MM_RC | Status API return. |
| { | Includes status or return code. If status is |
| int status; | 0 or success then the requestID is valid |
| uint16_t requestID; | and holds the unique command ID (or tag) |
| } | for the command. |
| struct MM_PROG | Progress API return. |
| { | Includes status or return code and the |
| int status; | command progress (e.g., a value between |
| uint8_t progress_percentage | 0 and 100 indicating percent complete). |
| } | |
| struct MM_CMD_OPTION | Optional Progress API parameter. |
| { | Enable fine-grained progress reporting |
| int enable_checkprogress; | Pointer to register callback function to be |
| void (*callback_function)(MM_RC status); | called upon command completion. |
| } | |
| struct MM_STAT | Cache Policy statistics API return. |
| { | Includes hit rate % and other CXL-related |
| float hit rate; | statistics. |
| uint64_t hit_count; | |
| uint64_t memrd_count; | |
| uint64_t memrddata_count; | |
| uint64_t meminv_count; | |
| uint64_t memspecrd_count; | |
| uint64_t memwr_count | |
| } | |

The application programming interface layer 124 may further include commands enabling the host 102 to manage the cache policy of the memory device 104. As mentioned above, the memory device 104 may use a small amount of DRAM (cache) and a large capacity NAND memory and may support a host-managed cache policy where the device cache 112 may be managed by the host 102.

Commands which support a host-managed cache policy, and which are shown in Table 2, provide prefetch and evict capabilities which allow a user or kernel process 122 to prefetch or read one or more data pages from the memory device nonvolatile memory 114 to the device cache 112 and to evict or mark as invalid one or more pages from the device cache 112 (and copy any modified contents back to the memory device nonvolatile memory 114). The commands also provide the capability to lock data values (e.g., pages of data). Locking a data value (or “placing a lock” on a data value) may prevent its eviction; and releasing the lock may make the data value eligible for eviction. In some embodiments, each page of data has a size of 4 kilobytes (KB). In some embodiments, an evict command sent by the host may override a previously sent lock command for the same address, and the effect of the evict command may be to (i) unlock the data and (ii) evict the data.

The command mm_prefetch, which may be called when the user or kernel process 122 determines that a memory range will be needed soon, takes a host virtual address, a length, and an option as arguments (the option being of type MM_CMD_OPTION, which is discussed above), and causes the memory device 104 to prefetch data from a range of addresses, specified by the address and length arguments. To accomplish this, the application programming interface layer 124 translates the host virtual address to a device physical address. The command mm_evict, which may be called when the user or kernel process 122 determines that a memory range is no longer needed, takes a host virtual address, a length, and an option as arguments (the option being of type MM_CMD_OPTION, which is discussed above), and causes the memory device 104 to evict data from a range of addresses, specified by the address and length arguments.

The command mm_lock, which may be called when a user or kernel process 122 determines that a memory range will continue to be needed (and therefore is not to be evicted), takes a host virtual address, a length, and an option as arguments (the option being of type MM_CMD_OPTION, which is discussed above), and causes the memory device 104 to lock data within a range of addresses, specified by the address and length arguments. The command mm_unlock, which may be called when a user or kernel process 122 determines that an ongoing need for a memory range has ended (and therefore the memory range may be made eligible for eviction), takes a host virtual address, a length, and an option as arguments (the option being of type MM_CMD_OPTION, which is discussed above), and causes the memory device 104 to release a lock on data within a range of addresses, specified by the address and length arguments.

As such, movement of data between the memory device nonvolatile memory 114 and the memory device cache 112 may be caused by either a command from the host (which may cause, as discussed above, prefetching, eviction, locking, and unlocking) or by the memory device, which may, e.g., cache data when it is read, and evict it based on a suitable eviction policy (e.g., based on a least recently used (LRU) eviction policy).

TABLE 2

| | |
|---|---|
| struct MM_RC mm_prefetch | Prefetch (read ahead) the memory area(s) |
| ( | beginning from a given logical address and |
| void *virt_address, /* host virtual address | for a number of 4 kB pages. |
| */ | Can optionally register a callback function |
| size_t length, /* size (4 kB aligned) */ | to be called upon completion or optionally |
| MM_CMD_OPTION option | enable fine-grained progress reporting. |
| ) | |
| struct MM_RC mm_evict | Evict the memory area(s) beginning from a |
| ( | given logical address and for a number of |
| void *virt_address, | 4 kB pages. |
| size_t length, | Can optionally register a callback function |
| MM_CMD_OPTION option | to be called upon completion or optionally |
| ) | enable fine-grained progress reporting. |
| struct MM_RC mm_lock | Lock the memory area(s) beginning from a |
| ( | given logical address and for a number of |
| void *virt_address, /* host virtual address | 4 kB pages. |
| */ | Can optionally register a callback function |
| size_t length, /* size (4 kB aligned) */ | to be called upon completion or optionally |
| MM_CMD_OPTION option | enable fine-grained progress reporting. |
| ) | |
| struct MM_RC mm_unlock | Unlock the memory area(s) beginning from |
| ( | a given logical address and for a number |
| void *virt_address, | of 4 kB pages. |
| size_t length, | Can optionally register a callback function |
| MM_CMD_OPTION option | to be called upon completion or optionally |
| ) | enable fine-grained progress reporting. |

In these commands, depending on the physical addresses to which the virtual address range corresponds, the Host API layer may form a list (for non-contiguous memory areas) or send a command to more than one memory device 104 (for multiple-device memory spaces). Such a list may be allocated in the memory device (or devices) 104 to which the command is being sent. The list may include memory area descriptions including physical address and length. The physical address and size of the list may be passed in the prefetch or evict command to the memory device 104. After receiving such a command, the memory device 104 may copy the list to the memory device controller memory 118 for processing.

The application programming interface layer 124 may receive a response message (for each command sent), from the memory device 104 to which the command was sent, which indicates the command status, including whether the command is in progress and whether the command is pending. The application programming interface layer 124 may receive at least one asynchronous response message from the memory device 104 indicating that the command has been completed. More than one asynchronous response message may be received if fine grained progress was enabled for the command. When the operation completes (successfully or unsuccessfully), the callback function (if one was registered) may be called by the application programming interface layer 124.

Hit rate reporting may be supported by the application programming interface layer 124. This feature may be used with or without the use of a host-managed cache policy. Commands for accomplishing this are shown in Table 3. The command mm_stat_read returns a structure of type MM_STAT (listed in Table 1) which includes, e.g., a hit count, a memory read count, a memory read data count, a memory invalidation count, a speculative memory read count and a memory write count. Similarly, the memory device 104 may be able to monitor, and report to the host 102, the access frequency of a memory location or of a page of data. Such reporting may be used by the host 102 to generate a heat map for the address range corresponding to the memory device 104. The command mm_stat_clear may clear the statistics counters in the memory device 104.

TABLE 3

| | |
|---|---|
| struct MM_STAT mm_stat_read ( ) | Return the device cache hit rate and other |
| | statistics. |
| void mm_stat_clear ( ) | Clear device statistics. |

In some embodiments (e.g., in the case of a Compute Express Link Memory Module-Hybrid memory device), the memory device 104 is not a persistent memory device from the perspective of the host, but it does contain nonvolatile memory e.g., the memory device nonvolatile memory 114. As such, the application programming interface layer 124 may provide flush capabilities which give the user or kernel process 122 the ability to write one or more pages from the memory device cache 112 to the memory device nonvolatile memory 114 without evicting the data or affecting the cache policy. A command for accomplishing this is shown in Table 4. The mm_flush command, which may be called when a user or kernel process 122 determines that data in a memory range needs to be persisted (e.g., saved in nonvolatile memory) takes a host virtual address, a length and, an option as arguments (the option being of type MM_CMD_OPTION, which is discussed above), and causes the memory device 104 to flush data (e.g., copy modified data from the memory device cache 112 to the memory device nonvolatile memory 114) from a range of addresses, specified by the address and length arguments.

TABLE 4

| | |
|---|---|
| struct MM_RC mm_flush | Return the device cache hit rate and other |
| ( | statistics. |
| void *virt_address, /* host virtual address | Can optionally register a callback function |
| */ | to be called upon completion or optionally |
| size_t length, /* size (must be 4 kB | enable fine-grained progress reporting. |
| aligned) */ | |
| MM_CMD_OPTION option | |
| ) | |

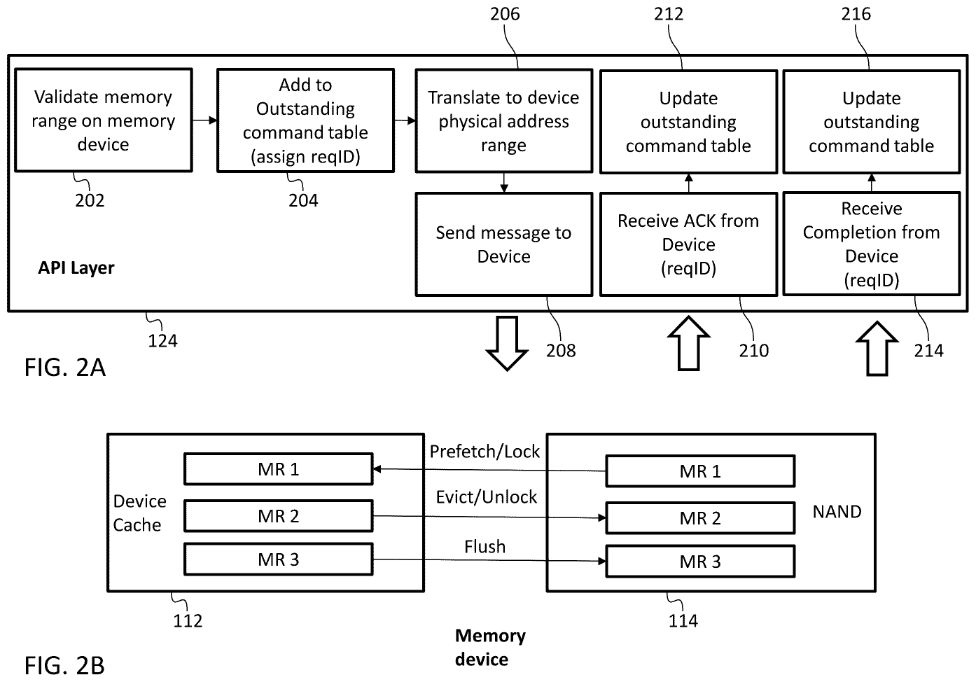

FIG. 2A shows examples of process flows. In a first operation 202, the application programming interface layer 124 validates the memory range it receives (specified by arguments of a command) (e.g., by confirming that the memory range corresponds to one or more memory devices 104), and, at 204, the application programming interface layer 124 assigns a command ID (reqID) to the command and adds the command to a table of outstanding commands. The application programming interface layer 124 translates, at 206, the address range specified by arguments of the command to a range of physical device addresses, and sends, at 208, the command (as a message, e.g., a CXL.io message) to the memory device 104. The application programming interface layer 124 then receives, at 210, an acknowledgement (ACK) from the memory device 104 and updates, at 212, the outstanding command table. The application programming interface layer 124 then receives, at 214, a completion (e.g., a command completion) from the memory device 104 (the completion including the command ID) and again, at 216, updates the outstanding command table. FIG. 2B shows data movements (in memory ranges MR 1, MR 2, and MR 3) that may occur between the memory device cache 112 and the memory device nonvolatile memory 114 as a result of prefetch, evict, lock, unlock and flush commands.

In some embodiments, the only connection between the host 102 and the memory device 104 is the PCIe connection between the host CPU 106 and the memory device cache controller. In some embodiments, the host 102 is not able to access the data in the memory device cache 112 and in the memory device nonvolatile memory 114 independently. Instead, load and store instructions executed by the host CPU 106 are handled by the memory device cache controller 110, which, for example, in response to a load instruction, returns data from the memory device cache 112, or, in case of a cache miss, from the memory device nonvolatile memory 114.

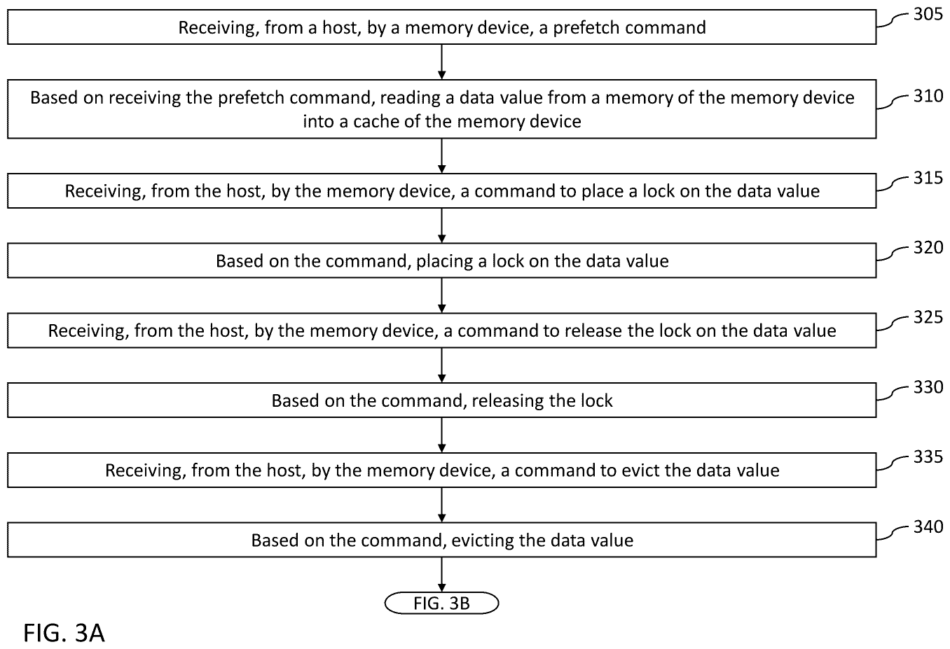

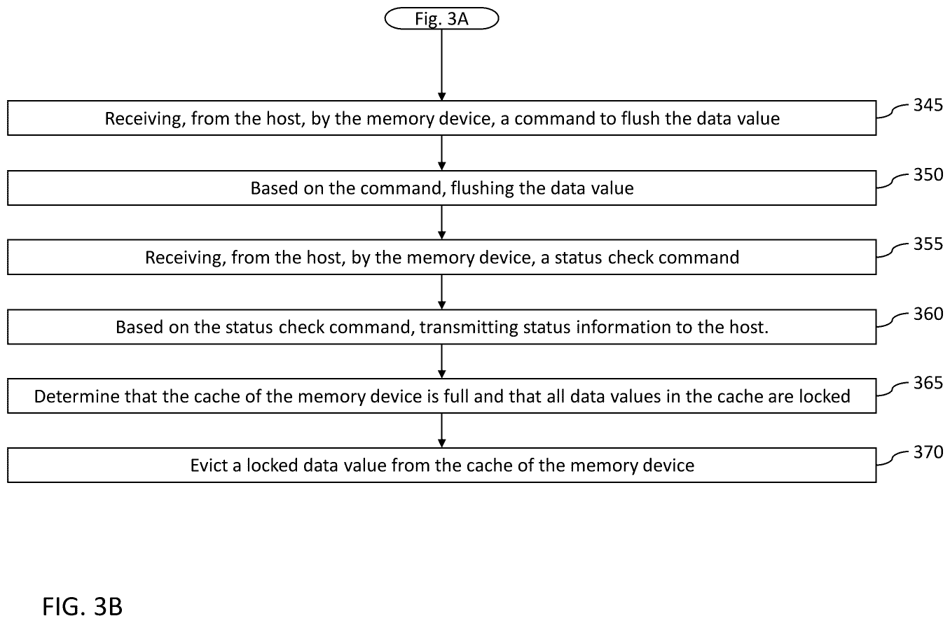

FIGS. 3A and 3B show aspects of a method of host-managed (or “host-initiated”) cache management, in some embodiments. Although FIGS. 3A and 3B illustrate various operations in such a method, embodiments according to the present disclosure are not limited thereto. For example, according to some embodiments, such a method may include additional operations or fewer operations, or the order of operations may vary (unless otherwise explicitly stated or implied) without departing from the spirit and scope of embodiments according to the present disclosure.

The method of FIGS. 3A and 3B includes receiving, at 305, from a host, by a memory device, a prefetch command, and, at 310, based on receiving the prefetch command, reading a data value from a memory (e.g., the memory device nonvolatile memory 114) of the memory device into a cache (e.g., the memory device cache 112) of the memory device. For example, as discussed above, when a user or kernel process 122 determines that a memory range will be needed soon, the user or kernel process 122 may call the prefetch command provided by the application programming interface layer 124 to ensure that, when needed, the data will be in the memory device cache 112. In some embodiments, the memory of the memory device (e.g., the memory device nonvolatile memory 114) is larger than the cache of the memory device. In some embodiments, the memory of the memory device includes nonvolatile memory. In some embodiments, the memory of the memory device includes a solid-state drive. In some embodiments, the memory device includes a controller, the controller including a processing circuit including a stored-program computer. In some embodiments, the memory device further includes a controller memory connected to the controller.

The method further includes receiving, at 315, from the host, by the memory device, a command to place a lock on the data value; and, at 320, based on the command, placing a lock on the data value. For example, as discussed above, when a user or kernel process 122 determines that a memory range will continue to be needed (and therefore is not to be evicted), the user or kernel process 122 may call the lock command provided by the application programming interface layer 124 to ensure that the data will not be evicted.

The method further includes receiving, at 325, from the host, by the memory device, a command to release the lock on the data value; and, at 330, based on the command, releasing the lock. For example, as discussed above, when a user or kernel process 122 determines that an ongoing need for a memory range has ended (and therefore the memory range may be made eligible for eviction), the user or kernel process 122 may call the unlock command provided by the application programming interface layer 124 to cause the data to be eligible for eviction.

If the memory device 104 receives a prefetch command from the host 102 when the memory device cache 112 is full and each data value in the memory device cache 112 is locked, the memory device 104 may (i) report to the host 102 that the memory device cache 112 is full and that all of the data values in the cache are locked or (ii) evict one or more locked data values so as to make it possible to execute the prefetch command (in which case it may report to the host 102 that certain locked data values have been evicted). If the memory device 104 reports to the host 102 that the memory device cache 112 is full and that all of the data values in the cache are locked, or that certain locked data values have been evicted, it may do so using a callback function (such as the callback function discussed above) or using any other method for reporting command status or error messages to the host 102. If the memory device 104 evicts one or more locked data values, it may evict the least recently used data value or data values.

The method further includes receiving, at 335, from the host, by the memory device, a command to evict the data value; and based on the command, evicting, at 340, the data value. For example, as discussed above, when the user or kernel process 122 determines that a memory range is no longer needed (and therefore is eligible for eviction), the user or kernel process 122 may call the evict command provided by the application programming interface layer 124 to cause the data to be evicted.

The method further includes receiving, at 345, from the host, by the memory device, a command to flush the data value; and, at 350, based on the command, flushing the data value. For example, as discussed above, when a user or kernel process 122 determines that data in a memory range needs to be persisted (e.g., saved in nonvolatile memory) the user or kernel process 122 may call the flush command provided by the application programming interface layer 124 to cause the data to be flushed.

The method further includes receiving, at 355, from the host, by the memory device, a status check command; and, at 360, based on the status check command, transmitting status information to the host. For example, as discussed above, the command mm_checkprogress provided by the application programming interface layer 124 may be called by the user or kernel processes 122 to determine progress of the command or whether it has been completed. In some embodiments, the status information comprises a status of a command (e.g., whether the command has been completed or (if fine progress monitoring is enabled) the extent to which it has been completed (specified, e.g., as a percentage)). In some embodiments, the status information comprises an operating statistic of the memory device. In some embodiments, the operating statistic comprises an access frequency of a memory location.

The method further includes determining, at 365, that the cache of the memory device (or the “memory device cache” 112) is full and that all data values in the cache are locked, and, based on determining that the memory device cache 112 is full and that all data values in the memory device cache 112 are locked, evicting, at 370, a locked data value from the memory device cache 112. For example, as discussed above in the context of commands that may be used by the host 102 to place a lock on one or more data values or to release one or more such locks, it may be that a command from the host 102 to prefetch data may conflict with a previously sent command to place locks on data, for example if the locked data values in the memory device cache 112 occupy so much space that too little space remains for the memory device 104 to execute the prefetch command. In such a circumstance, one possible course of action for the memory device 104 may be to evict certain locked data values, so as to free up sufficient space in the memory device cache 112 for the prefetch command to be executed.

As used herein, “a portion of” something means “at least some of” the thing, and as such may mean less than all of, or all of, the thing. As such, “a portion of” a thing includes the entire thing as a special case, i.e., the entire thing is an example of a portion of the thing. As used herein, when a second quantity is “within Y” of a first quantity X, it means that the second quantity is at least X-Y and the second quantity is at most X+Y. As used herein, when a second number is “within Y %” of a first number, it means that the second number is at least (1−Y/100) times the first number and the second number is at most (1+Y/100) times the first number. As used herein, the term “or” should be interpreted as “and/or”, such that, for example, “A or B” means any one of “A” or “B” or “A and B”.

The background provided in the Background section of the present disclosure section is included only to set context, and the content of this section is not admitted to be prior art. Any of the components or any combination of the components described (e.g., in any system diagrams included herein) may be used to perform one or more of the operations of any flow chart included herein. Further, (i) the operations are example operations, and may involve various additional steps not explicitly covered, and (ii) the temporal order of the operations may be varied.

Each of the terms “processing circuit” and “means for processing” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

As used herein, when a method (e.g., an adjustment) or a first quantity (e.g., a first variable) is referred to as being “based on” a second quantity (e.g., a second variable) it means that the second quantity is an input to the method or influences the first quantity, e.g., the second quantity may be an input (e.g., the only input, or one of several inputs) to a function that calculates the first quantity, or the first quantity may be equal to the second quantity, or the first quantity may be the same as (e.g., stored at the same location or locations in memory as) the second quantity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed herein could be termed a second element, component, region, layer or section, without departing from the spirit and scope of the inventive concept.

The terminology used herein is for the purpose of describing particular embodiments only and is not intended to be limiting of the inventive concept. As used herein, the terms “substantially,” “about,” and similar terms are used as terms of approximation and not as terms of degree, and are intended to account for the inherent deviations in measured or calculated values that would be recognized by those of ordinary skill in the art.

As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the present disclosure”. Also, the term “exemplary” is intended to refer to an example or illustration. As used herein, the terms “use,” “using,” and “used” may be considered synonymous with the terms “utilize,” “utilizing,” and “utilized,” respectively.

Any numerical range recited herein is intended to include all sub-ranges of the same numerical precision subsumed within the recited range. For example, a range of “1.0 to 10.0” or “between 1.0 and 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Similarly, a range described as “within 35% of 10” is intended to include all subranges between (and including) the recited minimum value of 6.5 (i.e., (1-35/100) times 10) and the recited maximum value of 13.5 (i.e., (1+35/100) times 10), that is, having a minimum value equal to or greater than 6.5 and a maximum value equal to or less than 13.5, such as, for example, 7.4 to 10.6. Any maximum numerical limitation recited herein is intended to include all lower numerical limitations subsumed therein and any minimum numerical limitation recited in this specification is intended to include all higher numerical limitations subsumed therein.

It will be understood that when an element is referred to as being “directly connected” or “directly coupled” to another element, there are no intervening elements present. As used herein, “generally connected” means connected by an electrical path that may contain arbitrary intervening elements, including intervening elements the presence of which qualitatively changes the behavior of the circuit. As used herein, “connected” means (i) “directly connected” or (ii) connected with intervening elements, the intervening elements being ones (e.g., low-value resistors or inductors, or short sections of transmission line) that do not qualitatively affect the behavior of the circuit.

Some embodiments may include features of the following numbered statements.

1. A method, comprising:
receiving, from a host, by a memory device, a prefetch command; and
based on receiving the prefetch command, reading a data value from a memory of the memory device into a cache of the memory device.

2. The method of statement 1, wherein the memory of the memory device is larger than the cache of the memory device.

3. The method of statement 1 or statement 2, wherein the memory of the memory device comprises nonvolatile memory.

4. The method of any one of the preceding statements, wherein the memory of the memory device comprises a solid-state drive.

5. The method of any one of the preceding statements, wherein the memory device comprises a controller, the controller comprising a processing circuit comprising a stored-program computer.

6. The method of statement 5, wherein the memory device further comprises a controller memory connected to the controller.

7. The method of any one of the preceding statements, further comprising:
receiving, from the host, by the memory device, a command to place a lock on the data value; and
based on the command, placing a lock on the data value.

8. The method of statement 7, further comprising:
receiving, from the host, by the memory device, a command to release the lock on the data value; and
based on the command, releasing the lock.

9. The method of any one of the preceding statements, further comprising:
receiving, from the host, by the memory device, a command to evict the data value from the cache of the memory device; and
based on the command, evicting the data value from the cache of the memory device.

10. The method of any one of the preceding statements, further comprising:
receiving, from the host, by the memory device, a command to flush a modified data value from the cache of the memory device to the memory of the memory device; and
based on the command, flushing the data value.

11. The method of any one of the preceding statements, further comprising:
receiving, from the host, by the memory device, a status check command; and
based on the status check command, transmitting status information to the host.

12. The method of statement 11, wherein the status information comprises a status of a command.

13. The method of statement 11 or statement 12, wherein:
the status information comprises an operating statistic of the memory device, and
the operating statistic comprises an access frequency of a memory location.

14. The method of any one of the preceding statements, further comprising:
determining that the cache of the memory device is full and that all data values in the cache are locked; and
based on determining that the cache of the memory device is full and that all data values in the cache are locked, evicting a locked data value from the cache of the memory device.

15. A memory device, comprising:
a memory; and
a cache,
the memory device being configured:
   to receive, from a host, a prefetch command; and
   based on receiving the prefetch command, to read a data value from the memory into the cache.

16. The memory device of statement 15, wherein the memory of the memory device comprises nonvolatile memory.

17. The memory device of statement 15 or statement 16, wherein the memory device is further configured:
to receive, from the host, a command to place a lock on the data value; and
based on the command, to place a lock on the data value.

18. The memory device of any one of statements 15 to 17, wherein the memory device is further configured:
to receive, from the host, a command to evict the data value from the cache of the memory device; and
based on the command, to evict the data value from the cache of the memory device.

19. A system, comprising:
a host; and
a memory device,
the memory device comprising:
   a memory; and
   a cache,
the host being configured to send, to the memory device, a prefetch command, and
the memory device being configured, based on receiving the prefetch command, to read a data value from the memory into the cache.

20. The system of statement 19, wherein the host is further configured:
to send, to the memory device, a command to place a lock on the data value; and
based on the command, to place a lock on the data value.

Although exemplary embodiments of a memory device with host-initiated cache operation have been specifically described and illustrated herein, many modifications and variations will be apparent to those skilled in the art. Accordingly, it is to be understood that a memory device with host-initiated cache operation constructed according to principles of this disclosure may be embodied other than as specifically described herein. The invention is also defined in the following claims, and equivalents thereof.

What is claimed is:

1. A method, comprising:
receiving, from a host, by a memory device, a prefetch command; and
based on receiving the prefetch command, reading a data value from a memory of the memory device into a cache of the memory device.

2. The method of claim 1, wherein the memory of the memory device is larger than the cache of the memory device.

3. The method of claim 1, wherein the memory of the memory device comprises nonvolatile memory.

4. The method of claim 3, wherein the memory of the memory device comprises a solid-state drive.

5. The method of claim 1, wherein the memory device comprises a controller, the controller comprising a processing circuit comprising a stored-program computer.

6. The method of claim 5, wherein the memory device further comprises a controller memory connected to the controller.

7. The method of claim 1, further comprising:
receiving, from the host, by the memory device, a command to place a lock on the data value; and
based on the command, placing a lock on the data value.

8. The method of claim 7, further comprising:
receiving, from the host, by the memory device, a command to release the lock on the data value; and
based on the command, releasing the lock.

9. The method of claim 1, further comprising:
receiving, from the host, by the memory device, a command to evict the data value from the cache of the memory device; and
based on the command, evicting the data value from the cache of the memory device.

10. The method of claim 1, further comprising:
receiving, from the host, by the memory device, a command to flush a modified data value from the cache of the memory device to the memory of the memory device; and
based on the command, flushing the data value.

11. The method of claim 1, further comprising:
receiving, from the host, by the memory device, a status check command; and
based on the status check command, transmitting status information to the host.

12. The method of claim 11, wherein the status information comprises a status of a command.

13. The method of claim 11, wherein:
the status information comprises an operating statistic of the memory device, and
the operating statistic comprises an access frequency of a memory location.

14. The method of claim 1, further comprising:
determining that the cache of the memory device is full and that all data values in the cache are locked; and
based on determining that the cache of the memory device is full and that all data values in the cache are locked, evicting a locked data value from the cache of the memory device.

15. A memory device, comprising:
a memory; and
a cache,
the memory device being configured:
to receive, from a host, a prefetch command; and
based on receiving the prefetch command, to read a data value from the memory into the cache.

16. The memory device of claim 15, wherein the memory of the memory device comprises nonvolatile memory.

17. The memory device of claim 15, wherein the memory device is further configured:
to receive, from the host, a command to place a lock on the data value; and
based on the command, to place a lock on the data value.

18. The memory device of claim 15, wherein the memory device is further configured:
to receive, from the host, a command to evict the data value from the cache of the memory device; and
based on the command, to evict the data value from the cache of the memory device.

19. A system, comprising:
a host; and
a memory device,
the memory device comprising:
a memory; and
a cache,
the host being configured to send, to the memory device, a prefetch command, and
the memory device being configured, based on receiving the prefetch command, to read a data value from the memory into the cache.

20. The system of claim 19, wherein the host is further configured:
to send, to the memory device, a command to place a lock on the data value; and
based on the command, to place a lock on the data value.
